(19) United States
(12) Patent Application Publication
(10) Pub. No.: US 2021/0002146 A1
(43) Pub. Date: Jan. 7, 2021

(54) ENVIRONMENTALLY FRIENDLY SEA WATER INTAKE PROCESS AND APPARATUS

(71) Applicant: IDE PROJECTS LTD., KADIMA (IL)

(72) Inventor: Boris LIBERMAN, Tel Aviv (IL)

(21) Appl. No.: 16/503,083

(22) Filed: Jul. 3, 2019

(51) Int. Cl. C02F 1/00; C02F 1/44; B01D 61/02

(52) U.S. Cl. CPC C02F 1/004; C02F 1/441; C02F 2103/08; B01D 61/022; B01D 61/025

(57) ABSTRACT

A sea water intake unit comprising a source of air (12), a substantially vertical pipe (10) having an air inlet and a sea water inlet for air lifting sea water in the substantially vertical pipe to a height above sea level, the depth of the inlet below sea level being sufficient to promote air lifting of the sea water to the height above sea level. The air lift delivers sea water to a pre-treatment filter unit (22) in fluid communication with the vertical pipe in which the rate of flow of the sea water is such as to separate out small marine life in an upper portion of the water from the lower filtered portion, and a discharge pipe (40) to return at least some of the sea water and marine life back to the sea. The intake unit may deliver the lower filtered water to a desalination plant (6) provided on a disused offshore platform (2).

### BACKGROUND TO THE INVENTION

Water treatment systems such as seawater desalination facilities and power plants that require an intake of water from sea water include an intake unit for delivering water from its source (e.g. sea) to the system, and a pre-treatment unit for removing floating and suspended material from the delivered water, in order to prepare the water for the main RO membrane process.

There are many different types of intake system but two intake types are more common: open intakes and infiltration intakes (or infiltration galleries). Open intakes draw water via piping directly from the water body. Open intakes typically employ screen meshes between 20 mm to 1 mm to filter out large debris and prevent fish or other marine life from being drawn into the system, such as the desalination system. However, millions of fish and other small marine organisms, are sucked into the piping or smear on the screen, leading to considerable damage, both to the environment and to facilities. Damage is inflicted on both large aquatic organisms such as fish or crabs that are trapped against the intake screens and drown or suffocate, and on small marine organisms such as fish, fish eggs or larvae that are drawn into the intake system and cause biofouling on the plant equipment.

Infiltration intakes, or galleries, are built in the seabed by the installation of horizontal drain systems. The drain system is placed in the natural filtration media sand, or cracked stone or other water permeable natural media and the seawater is slowly filtered by it. This media is naturally cleaned by waves and storms. Horizontal drain systems deliver water to the pumping station located on the seashore. Infiltration galleries, while protecting the marine environment, can only be installed in areas with naturally occurring medias. Furthermore, a huge area of sea is required and the filtration velocity is typically very slow. After a certain period of time, flow is diminished and a new area has to be selected for intake.

Ranney wells are also used to provide lateral screens for water intake. A caisson is constructed into the sand below surface level and the screened conduits extend horizontally from ports in the caisson to provide an infiltration gallery with a single central withdrawal point. However, this is only suitable for providing intake water to plants of small size.

Environmental Protection Agencies are requiring further improvements to intake units to minimize adverse environmental impacts, in particular reducing mortality to fish, fish eggs and other aquatic organisms. Water intakes conventionally impact most severely on early life stages of fish and shellfish through impingement and entrainment. It is desirable to reduce mortality of small fish, eggs and larva that are introduced into the intake units in addition to larger aquatic organisms.

This situation is exacerbated due to climate change which is significantly increasing the number of people that do not have access to clean water. In many places, squeezing fresh water from the ocean might be the only viable way to increase the supply. As a result, sea water desalination plants will be increasingly relied upon to provide a substantial proportion of the world population's water supply. Thus, this is likely to impact further on marine life.

Desalination is an energy-intensive process that extracts fresh water from seawater transforming it into water that's fit for human consumption. There are now nearly 16,000 desalination plants either active or under construction across the globe. Desalination technology uses a process of reverse osmosis (RO) of Nano Filtration (NF) wherein sea water is forced through a membrane under pressure allowing water molecules to pass through but blocking salt ions and other impurities. These types of plant may enable local population water demands to be met but these desalination plants are extremely large scale and are primarily land-based. A significant amount of land, generally close to the sea, is required for building of the plant. This adds to the high cost of the process and is environmentally unfriendly, with the near-to-shore intake pipes for delivering sea water to the plant being detrimental to marine life.

It would be desirable to reduce the land-based footprint of a desalination plant, thereby minimizing the harmful effect on environmental coastal areas. Attempts have been made, such as the provision of floating desalination plants, for example having a ship installed with a desalination plant with fresh water piped inland. However, these types of plant are limited in size and experience problems associated with rough sea waters. Offshore oil and gas platforms have been installed and used extensively throughout the 1900's to produce large amounts of oil and gas. However, such platforms have a limited life span and must be decommissioned after use in a safe and responsible manner. This is an extremely expensive and represents an enormous engineering challenge. It is also necessary to protect marine life on and around the platform. Aquatic organisms invariably attach themselves to the undersea portions of oil platforms, turning them into artificial reefs. This attracts other marine life, such as fish which feed off the platforms, thus resulting in fish populations increasing in the vicinity of such platforms.

It is an object of the present invention to provide an improved seawater intake unit that aims to reduce the mortality of aquatic life, in particular small fish, fish eggs and larva.

It is a further object of the present invention to provide a method and apparatus for the desalination of saline water, particularly sea water, that aim to overcome, or at least alleviate, the above-mentioned problems.

### SUMMARY OF THE INVENTION

A first aspect of the present invention provides a method for delivering sea water to a water treatment plant, the method comprising the steps of:
(a) delivering air to at least one inlet in a substantially vertical pipe having at least one sea water inlet at a depth below sea level and air lifting sea water in the substantially vertical pipe to a height above sea level, the depth of the inlet below sea level being sufficient to promote air lifting of the sea water to the height above sea level;
(b) passing at least part of the sea water through a pre-treatment filter unit at a flow rate sufficiently low to retain small fish, eggs and other small marine life in another part of the sea water above the filter unit;
(c) discharging the small fish, eggs and other marine life to the sea with a proportion of the air lifted sea water; and
(d) delivering the remaining proportion of sea water comprising the filtered water to a treatment plant.

A second aspect of the present invention provides a sea water intake unit comprising:
(a) a source of air;
(b) a substantially vertical pipe having at least one air inlet and at least one sea water inlet provided in sea water at depth below sea level, said source of air delivering air to an anterior of the vertical pipe to airlift the sea water through the vertical pipe to a height above sea level, the depth of the inlet below sea level being sufficient to promote air lifting of the sea water to said height above sea level;
(c) a pre-treatment filter unit in fluid communication with the vertical pipe, the sea water passing through the filter unit at a flow rate sufficiently low to retain small fish, eggs and other small marine life in another part of the sea water above the filter unit to separate small fish, eggs and other small marine life from the remaining proportion of water;
(d) a discharge pipe to return at least some of a proportion of the air lifted sea water with the marine life back to the sea; and
(e) a delivery pipe to deliver the remaining proportion of the sea water comprising the filtered water to a treatment plant.

Preferably, both the air-lift process and the back to sea discharge pipe are substantially free from moving parts in which marine life, in particular small fish and eggs, could become trapped, leading to injury or death. The filtration process is very slow and also cannot injure or kill aquatic organisms. In this respect, the filter media preferably comprises sand with the water velocity passing through the sand media is less than 0.01 m per second or less than 10 mm per second, more preferably about 0.001-0.006 m per second or 1-6 mm per second. Such extremely low velocity flow is not able to damage any aquatic organism. Furthermore, aquatic organisms may be provided with nutrition left on the sand filter surface after seawater filtration.

In a preferred embodiment, the balance of the flow of sea water between lifting up the seawater and the filtered seawater is arranged in such a way that the flow of the filtered water is significantly less than the flow of the lifted seawater. Excess seawater is continuously discharged back to the sea. Examples of suitable flow rates through the apparatus of the present invention are 100 m³/hr for water lifted from the sea to the filtration area, 70 m³/hr passing through the filtration process and 30 m³/hr for discharge back to the sea. However, it is to be appreciated that the invention is not limited to these flow rates.

The air is preferably pumped to the bottom of the vertical pipe which causes the sea water and any associated marine life to be air lifted to the top of the vertical pipe, above sea level. This is a well known airlift pumping concept.

The lower air inlet of the vertical airlift pipe and/or the sea water inlet of the pipe is preferably protected by a large mesh screen, for example having apertures of around 50 mm×50 mm, to prevent entry of large marine life, such as big fish.

The vertical pipe is preferably in fluid communication with a reservoir containing or positioned above the surface of the filtration media, comprising the pre-treatment unit, the reservoir being in fluid communication with the discharge pipe. Preferably, the reservoir is provided with the filter media, such as sand. As an option ultra filtration fibers may be implemented instead of or in addition to filtration media. A drainage channel is provided below the filter media wherein the drainage channel delivers the filtered water to the treatment plant. Any marine life remains above the filter media and is returned to the sea in the discharge pipe. Preferably, the discharge pipe is of a small gradient, for example being at least 30° off vertical, preferably at least 45° off vertical so as to gently deliver marine life back to the sea unharmed.

The pre-treatment unit preferably includes a cleaning apparatus for periodical cleaning of the filter media, such as sand. Preferably, the cleaning apparatus comprises one for gentle agitation of the filter media to prevent damage to marine life above the filter media. In a preferred embodiment, the cleaning apparatus is a local backwashing system for cleaning of portions of the filter media consecutively, to eventually backwash the whole volume of the filter media, for example around every 300 hours

Preferably, the cleaning apparatus comprises an enclosure having a closed upper end and an open lower end. Preferably, the enclosure is supported on a rotating bridge extending across the reservoir, wherein the enclosure is configured to be sunk into the filter media to surround a portion of it. The submerged enclosure is supported on the drainage layer and sinking of the enclosure is carried out by lowering the air pressure in its upper part. Once sunk, the lowered air pressure in the upper part is used to initiate suction in the enclosure which serves to expand the enclosed portion of the filter media and removes water and sludge from it. Once this water with sludge is removed, the enclosed portion of filter media is allowed to settle before raising the enclosure out of the filter media by increasing air pressure in its upper part. Once raised, the enclosure floats above the filter media and can be moved to another area by bridge. In this manner, the entire filter media may be cleaned without having to stop operation of the pre-treatment unit and without damage to marine life above the filter media.

This moving enclosure is termed ‘Spot Cleaner’ and in a preferred embodiment consists of a cylinder with an end area of 1 to 10 m². However, some other geometry of Spot Cleaner may be utilised. The Spot Cleaner penetrates into the filtration media, generally sand, in this small area only, until it reaches the drainage channel. Media is cleaned by means of sucking filtrated water from the drainage channel through the media in a backwash process. In this procedure all cleaning is absolutely isolated from the other filter surface and other parts of the filter media, thereby ‘spot’ cleaning. Interaction between aquatic organisms and the backwash process takes place only when the Spot Cleaner moves from one spot position to another spot. To diminish interaction with aquatic organisms, it is preferable for the bottom edge of the cylinder to not be lifted above the surface of the sand. In operation, it moves a few millimeters within the sand media, pushing aside and moving around the filter media. This backwash procedure provides complete isolation between backwashing activity and aquatic organisms present on the sand surface area.

Preferably, a skirt is provided around the open lower end of the enclosure to further reduce damage to marine life.

The present invention relies on the intake unit being situated at a great enough depth to enable an airlift to be operational to deliver the sea water and marine life to the reservoir. Generally, sea water that is to be delivered to a treatment plant has to be piped at least 5 metre above sea level, often substantially more. This generally means that the source of air to the vertical pipe must be provided at a depth at least tenfold the height of the plant, e.g. at least 50 metre below sea level.

Conventionally, water treatment plants, such as desalination plants, are positioned close to the shore and such land poisoned intake water is not able to pump water into a pre-treatment unit without mechanical impellers which damage or kill fish eggs. The present invention solves this problem by the intake pipe being placed further out to sea. In a preferred embodiment, the treatment plant itself is at least partially provided out to sea, especially being provided on a disused offshore platform located in the sea, wherein the depth of the sea is tenfold greater than the height of the platform on which the water treatment takes place.

Thus, a third aspect of the present invention provides a method for desalination of sea water, the method comprising the steps of:
(a) installing at least one semi-permeable membrane on a disused offshore platform located in the sea;
(b) obtaining sea water from the surrounding sea, preferably according to the airlift method according to the first aspect of the present invention, pressurizing the sea water and delivering the pressurized sea feed water through the at least one semi-permeable membrane on the disused oil platform to provide desalinated product water and brine; and
(c) delivering the desalinated product water directly or indirectly to a land-based site.

A fourth aspect of the present invention provides an apparatus for the desalination of sea water, the apparatus comprising:
(a) a sea water intake unit, preferably wherein the sea water intake unit is an airlift unit according to the second aspect of the present invention:
(b) a disused offshore platform located in the sea, the platform supporting at least one semi-permeable membrane for receiving sea water from the sea water intake pipe, the at least one semi-permeable membrane providing desalinated product water and brine; and
(c) a pipeline to deliver the desalinated product water directly or indirectly to land.

In the context of this disclosure, a disused offshore platform means any type of platform that is provided in the sea that has been used for oil or gas production but is no longer in use and therefore would normally be decommissioned.

The method according to the third aspect of the present invention preferably includes mixing the brine with sea water and returning it to the sea surrounding the offshore platform. An outlet may be provided to deliver diluted brine to the sea surrounding the offshore platform.

Brine which has specific gravity above seawater, can be discharged by other deep pipe to the bottom of sea. Brine, having a higher specific gravity then seawater, does not mix-up easily and will be discharged in laminar regime out from a brine discharge point.

Ideally, pipelines that had previously been used to transport fluids to and/or from the offshore platform are utilised in the desalination plant to transport fluid to and/or from the site.

Preferably, the at least one semi-permeable membrane is a reverse osmosis or Nano filtration membrane, albeit other types of membranes suitable for desalination of sea water may be used. Preferably, an array of pressure vessels containing multiple reverse osmosis membranes is provided on the offshore platform.

Preferably, a pre-treatment unit is included on the offshore platform for treating the sea water prior to its delivery to the semi-permeable membranes. A post-treatment unit may also treat the desalinated water. Post-treatment may be carried out on the offshore platform or once the product water is taken to land, on-shore.

Desalinated water may be transferred to shore by barges. Alternatively, post treatment processes may be carried on those barges, during product water loading, transportation and/or uploading.

Preferably, the apparatus includes the sea water intake unit according to the second aspect of the present invention, wherein at least part of the offshore platform provides the reservoir for sea water, the reservoir having a filter media supported on a drainage channel. The airlift intake pipe preferably delivers sea water to the reservoir for filtration through the filter media and collection in the drainage channel. A delivery pipe is then provided for transporting the filtered sea water to the semi-permeable membrane.

Preferably, the offshore platform is provided on multiple levels with the pre-treatment unit provided on a lower level and the reverse osmosis membrane provided on an upper level.

In a preferred embodiment, the pre-treatment unit is also provided with a cleaning apparatus for cleaning of the filter media.

It is to be appreciated that as much as possible of the existing structure of the offshore platform is utilised for the desalination plant. However, the existing structure may also require some adaptation to make it fit for purpose.

### BRIEF DESCRIPTION OF THE DRAWINGS

An embodiment of the invention shall now be described, by way of example only, with reference to the accompanying drawings in which:

FIG. 1 is a schematic diagram of a desalination plant installed on a disused oil platform fed by an air life intake pipe according to one embodiment of the present invention;

FIG. 2A is a schematic diagram of a desalination plant installed on a disused oil platform having an airlift intake pipe and reservoir provided with a spot cleaner according to another embodiment of the present invention; and

FIG. 2B is a section along line A-A of FIG. 2A.

### DETAILED DESCRIPTION OF THE INVENTION

The present invention provides a novel combination of a sea water intake, filtration technology, and a discharge pipe unit for the delivery of sea water to a treatment plant, such as a desalination plant. The intake unit is in the form of an airlift pump wherein air is delivered to sea water at a depth sufficiently greater than the height that the sea water is to be delivered to on the plant so that air lift of the water may be achieved. For example, if the plant is 5 m above sea level, the air may be pumped to a depth of at least 50 m below sea level. The air is introduced at the base of an open substantially vertical pipe which enables sea water to enter and be airlifted to above sea level, ideally being provided with a screen to prevent entry of any fish above a certain size. This enables marine life, including small fish and eggs, to be delivered to above sea level without damage.

The vertical pipe is in fluid communication with a reservoir comprising a pre-treatment unit, and the reservoir is in fluid communication with a discharge pipe for returning sea water back to the sea. The reservoir is provided with a filter media having a discharge channel therebeneath so that the water may be filtered through the media. The filtered water is then directed to the treatment plant for further treatment. Marine life remains above the filtered water in the reservoir and passes out through the discharge pipe without pumping back to the sea, preventing any harm to the marine life. In this manner, the intake pipe and pre-treatment unit gently lift, filter and return water containing marine life back to the sea without any harmful mechanical parts which may cause impingement and entrainment thereof, while filtered sea water is delivered on to the treatment plant.

It is critical with the present invention to provide the intake unit at a sufficient depth within the sea to enable the airlift to operate. Intake units located close to the shore are unlikely to provide the required depth except in particular geographical areas. Therefore, in one embodiment of the present invention, a desalination plant is provided that uses a disused offshore platform in the sea. An oil platform, offshore platform, or offshore drilling rig is a large structure with facilities for well drilling to explore, extract, store, and process petroleum and natural gas which lies in rock formations beneath the seabed. There are a large number of such platforms located out to sea that pump oil or natural gas from beneath the seabed. These platforms have a limited lifespan from oil availability point of view, generally around 10 years, but they are mechanically able to stay in sea about 30 years. This imbalance of oil reserve against mechanical ability of platform to stay in the sea provides the possibility to use it for another purpose, during the 20 years or so before the platforms should be disbanded and removed.

The present invention may adapt a disused offshore platform to support at least part of a desalination plant, in particular at least an array of pressure vessels containing semi-permeable membranes, such as reverse osmosis membranes. This solves multiple problems simultaneously, providing the plant in deep sea areas which would enable operation of a vertical air lift for delivery of the sea water to the plant, removing the need to dismantle the offshore platform while significantly reducing the land-based footprint of a desalination plant in coastal areas. The offshore platforms are also considerably stable, being drilled deep into the rock formation beneath the sea. Furthermore, most platforms are already provided with electrical generators which may be utilised for at least partial running of the desalination plant and pipelines for delivery of product directly to the shore.

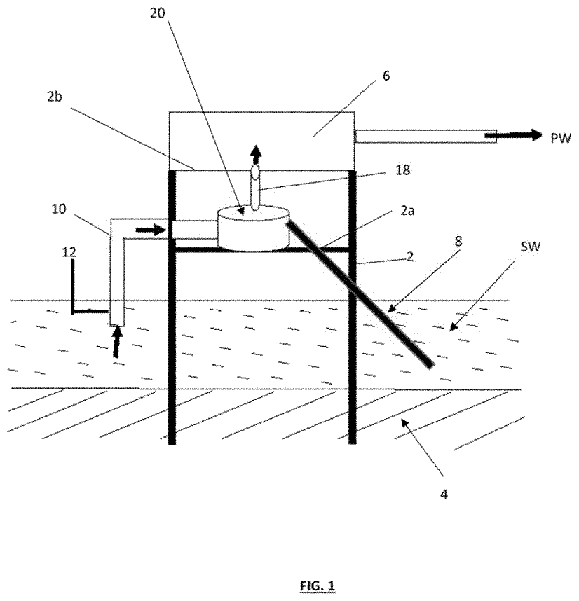

Referring to FIG. 1 of the accompanying drawings, a suitable disused offshore platform 2 is identified for re-use as a desalination plant with an intake unit according to the present invention. The platform 2 is already firmly secured to the seabed 4 with sea water surrounding the legs of the platform. A reverse osmosis (RO) plant 6, consisting of an array of pressure vessels (not shown) containing the RO membranes is constructed on a top main level 2b of the platform and a pre-treatment unit, such as a filter system 20, is provided on a lower level 2a of the platform. In its most basic form, air 12 is introduced into vertical intake pipe 10 to airlift sea water SW from the sea through intake pipe 10 to the pre-treatment unit 20 on the offshore platform where part of feed flow 8 with aquatic organisms is discharged back to sea. It is then delivered via delivery pipe 18 to the reverse osmosis plant 6 on the main level of the platform wherein desalinated product water PW is produced and delivered back to land by suitable means (not shown). Waste brine (not shown) may be diluted and returned to the sea.

The pre-treatment unit is a filter media comprising sand with the water passing through the sand media very slowly, such as less than 0.01 m per second or less than 10 mm per second, more preferably about 0.001-0.006 m per second or 1-6 mm per second. Such extremely low velocity flow is not able to damage any aquatic organism. Furthermore, aquatic organisms may be provided with nutrition left on the sand filter surface after seawater filtration. In this manner, at least part of the sea water passes through the pre-treatment filter unit at a flow velocity sufficiently low to retain small fish, eggs and other small marine life in another part of the sea water above the filter unit. These small fish, eggs and other marine life are then discharged back to the sea with a proportion of the air lifted sea water while the remaining proportion of the sea water comprising the filtered water is delivered to the treatment plant 6.

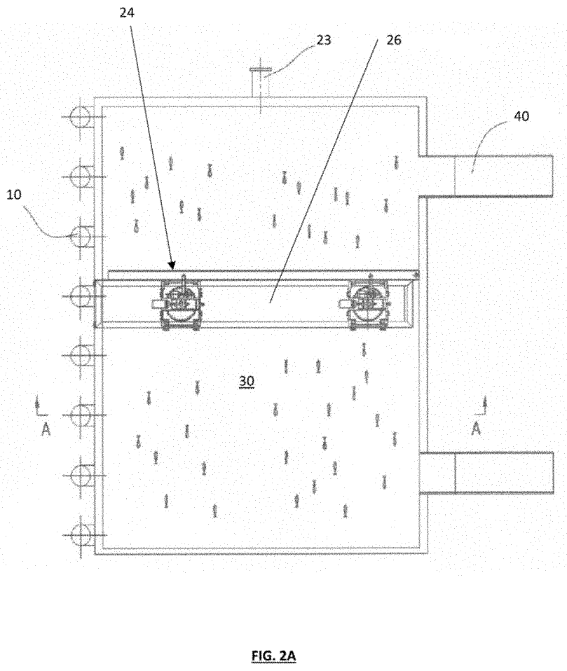

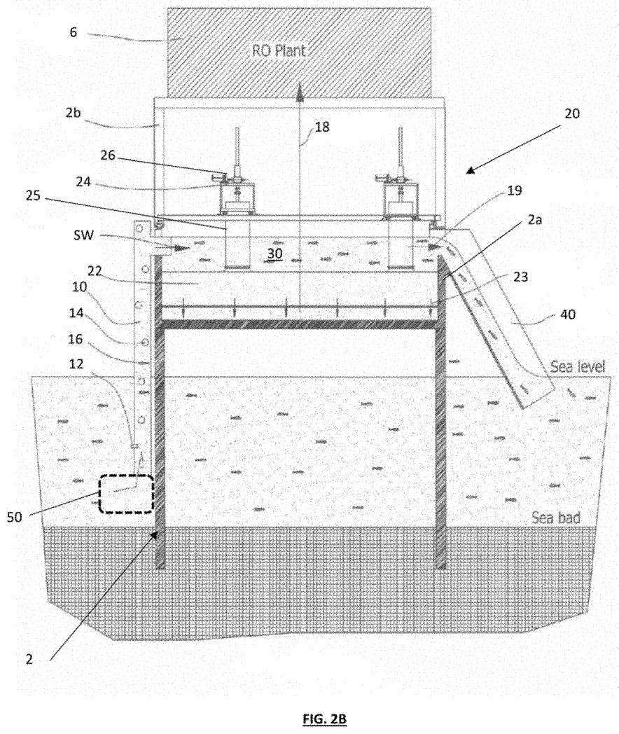

FIGS. 2A and 2B of the accompanying drawings illustrate a preferred intake unit and desalination plant according to the present invention. The pre-treatment unit 20 and RO plant 6 are again provided on an offshore platform 2 that is no longer in service with the lower level 2a of the platform defining a reservoir 30 provided with a filtering system 22 and local backwashing system 24 and a higher level platform 2b supporting the array of pressure vessels and associated pipework. It is to be appreciated that the different levels of the platform may be already present prior to installation of the desalination plant or may be constructed on the existing platform, if necessary. Alternatively, depending upon the size of the existing platform, these features may be provided on the same level.

The vertical intake pipe 10 pumps sea water to the top of the reservoir by means of an air lift, with the reservoir 30 free water area constituting the top of the pre-treatment unit 20. The intake includes a large mesh screen 50 to prevent entry of big fish into pipe 10 and an air nozzle 12 so air bubbles 14 are created in the pipe. This allows small marine life 16, such as small fish, larvae and eggs to enter the intake pipe and be delivered to the reservoir 30 without damage. Filter media 22, such as sand is provided in the lower part of the reservoir and is supported on a drainage channel 23 which is in fluid communication with delivery pipe 18 for delivering the filtered water to the RO plant in the top level. Any marine life 16 remains above the filter media and exits along an evacuation slope 40 back into the sea via a return flow 19. The evacuation slope is more gradual than the intake pipe so as prevent any damage occurring to the marine life when they are delivered back to the sea.

Additionally, the pre-treatment unit 20 includes a local backwashing system 24 such as that described in the Applicant's published application No. WO 2013/118031. This allows cleaning of portions of the filter media 22 consecutively, to eventually backwash the whole volume of the filter media by small areas each time (‘Spots’). It comprises an enclosure 25 supported on a moving bridge 26 extending across the reservoir 30 and the enclosure may be sunk into the filter media to surround a portion of it. The submerged enclosure is supported on the drainage layer 23 and sinking of the enclosure is carried out by lowering the air pressure in its upper part. Once sunk, the lowered air pressure in the upper part is used to initiate suction in the enclosure which serves to expand the enclosed portion of the filter media and removes water and sludge from it. Once this water with sludge is removed, the enclosed portion of filter media is allowed to settle before raising the enclosure out of the filter media by increasing air pressure in its upper part. Once raised, the enclosure floats above the filter media and can be moved to another area (another ‘Spot’) by bridge 26. In this manner, the entire filter media may be cleaned without having to stop operation of the pre-treatment unit.

It is to be appreciated that multiple vertical intake pipes 10 and multiple evacuation slopes 40 can be provided to deliver sea water to the reservoir and return it to the sea. Preferably, multiple smaller diameter intake pipes 10 and fewer, wider evacuation slopes 40 are provided, as illustrated in FIG. 2A.

Operation of the plant is as follows. An excess amount of sea water required for desalination is sucked into intake pipe with any surrounding small marine life and air lifted to the reservoir 30. The required amount of sea water for desalination is filtered through filter media 22, passes into drainage channel 23 and the filtered water is then delivered to the RO plant 6 provided at the top level of the platform. The remaining part of seawater above the filter media contains aquatic organisms, and is discharged by a pipe, channel or slope 40 back to the sea.

The filtered water passes through an array of pressure vessels containing reverse osmosis membranes to produce purified water on one side of the membrane and a relatively concentrated brine on the other. In this respect, the filtered sea water is pressurised and passed through a reverse osmosis membrane with the permeate encouraged to flow through the membrane by the pressure differential created between the pressurized sea water and the product water, which is at near-atmospheric pressure. The product water PW may be subjected to post-treatments, either on the platform or after it is delivered to land. Any suitable means may be provided to transport the product water to land but preferably a pipeline is provided between the platform and land. Ideally, the pipeline previously used to deliver oil or gas from the platform is re-commissioned for transport of the product water.

There are many different types of offshore platform in existence, the majority of which may be suitable for re-commissioning as a desalination plant and for use with an airlift intake pipe due to the significant depth of the sea surrounding the platform Conventional fixed platforms built on concrete or steel legs that are anchored directly into the sea bed would be the preferred choice. However, other types may be equally as suitable, such as compliant towers, a gravity-based structure, semi-submersible platforms, tension leg platforms and spar platforms.

Whilst the intake unit of the present invention is illustrated in conjunction with a desalination plant installed on a dis-used oil platform it is to be appreciated that this need not be the case, provided the vertical intake pipe can be located at a sufficient depth below sea water to provide adequate above sea level for delivering the sea water to the pre-treatment unit. However, it is clear that the utilisation of the dis-used platform may be the preferred option, since not only will it be situated in the sea having the required depth but will also reduce the amount of land utilised for desalination plants going forward and limit the need to decommission offshore platforms which is an extremely costly process. Not only will the airlift intake unit of the invention reduce damage to marine life, but the retention of the platform within the sea will also preserve marine life attached to or surrounding the platform.

1. A method for delivering sea water to a water treatment plant, the method comprising the steps of:
(a) delivering air to at least one inlet in a substantially vertical pipe having at least one sea water inlet at a depth below sea level and air lifting sea water in the pipe to a height above sea level, the depth of the inlet below sea level being sufficient to promote air lifting of the sea water to said height above sea level;
(b) passing at least part of the sea water through a pre-treatment filter media at a flow rate sufficiently low to retain small fish, eggs and other small marine life in another part of the sea water above the filter media;
(c) discharging the small fish, eggs and other marine life to the sea with a proportion of the airlifted seawater; and
(d) delivering the remaining proportion of sea water comprising the pre-treated filter water to a treatment plant.

2. The method according to claim 1 wherein the flow rate of the water passing through the filter media is less than 0.01 m per second or less than 10 mm per second.

3. The method according to claim 1, further comprising periodically backwashing said filter media.

4. The method according to claim 1 wherein the rate of flow of sea water is highest during air lifting of the water and diminishes with each subsequent step to the discharge of the water to the sea.

5. A sea water intake unit comprising:
(a) a source of air;
(b) a substantially vertical pipe having at least one air inlet and at least one sea water inlet provided in sea water at depth below sea level, said source of air delivering air to an anterior of the vertical pipe to airlift the sea water through the vertical pipe to a height above sea level, the depth of the inlet below sea level being sufficient to promote air lifting of the sea water to said height above sea level;
(c) a pre-treatment filter unit in fluid communication with the vertical pipe, the sea water passing through the filter unit at a flow rate sufficiently low to retain small fish, eggs and other small marine life in another part of the sea water above the filter unit to separate the small fish, eggs and other small marine life from the remaining proportion of the sea water;
(d) a discharge pipe to return at least a proportion of the air lifted sea water with the marine life back to the sea; and
(e) a delivery pipe to deliver the remaining proportion of the sea water comprising the pre-treated filtered water to a treatment plant.

6. The sea water intake unit as claimed in claim 5 wherein the substantially vertical pipe is in fluid communication with a reservoir comprising the pre-treatment filter unit, the reservoir being in fluid communication with the discharge pipe and wherein the reservoir is provided with a filter media with a drainage channel below for flow of the filtered water to the delivery pipe for delivery to the treatment plant.

7. The sea water intake unit as claimed in claim 6 wherein the pre-treatment unit includes a cleaning apparatus for cleaning of the filter media, the cleaning apparatus comprising a local backwashing system for cleaning discrete portions of the filter media consecutively, to eventually backwash the whole volume of the filter media.

8. The sea water intake unit as claimed in claim 5 wherein a mesh screen is provided across the sea water inlet of the vertical pipe to prevent entry of organisms above a minimum size.

9. The sea water intake unit as claimed in claim 5 wherein the discharge pipe is at least 30° off vertical.

10. An apparatus for the desalination of sea water, the apparatus comprising:
(a) a sea water intake unit;
(b) a disused offshore platform located in the sea, the platform supporting at least one semi-permeable membrane for receiving sea water from the sea water intake pipe, the at least one semi-permeable membrane providing desalinated product water and brine; and
(c) a pipeline to deliver the desalinated product water directly or indirectly to land.

11. The apparatus for the desalination of sea water as claimed in claim 10 wherein the sea water intake unit comprises:
(a) a source of air;
(b) a substantially vertical pipe having at least one air inlet and at least one sea water inlet provided in sea water at depth below sea level, said source of air delivering air to an anterior of the vertical pipe to airlift the sea water through the vertical pipe to a height above sea level, the depth of the inlet below sea level being sufficient to promote air lifting of the sea water to said height above sea level;
(c) a pre-treatment filter unit in fluid communication with the vertical pipe, the sea water passing through the filter unit at a flow rate sufficiently low to retain small fish, eggs and other small marine life in another part of the sea water above the filter unit to separate the small fish, eggs and other small marine life from the remaining proportion of the sea water;
(d) a discharge pipe to return at least a proportion of the air lifted sea water with the marine life back to the sea; and
(e) a delivery pipe to deliver the remaining proportion of the sea water comprising the pre-treated filtered water to a treatment plant.

12. The apparatus as claimed in claim 10 wherein a pre-treatment filter unit is included on the offshore platform for treating the sea water prior to its delivery to the semi-permeable membranes.

13. The apparatus as claimed in claim 10 wherein at least part of the offshore platform provides a reservoir for sea water, the reservoir being in fluid communication with the intake pipe and having a filter media supported on a drainage channel to provide a pre-treatment unit.

14. The apparatus as claimed in claim 13 wherein the offshore platform is provided on multiple levels with the pre-treatment unit provided on a lower level and the reverse osmosis membrane provided on an upper level.

15. An apparatus as claimed in claim 10 wherein an outlet is provided to deliver diluted brine from the offshore platform to the sea surrounding the platform.

16. An apparatus as claimed in claim 10 wherein existing pipelines of the offshore platform deliver desalinated product water to land.

17. An apparatus as claimed in claim 11 wherein the discharge pipe has a gradient of at least 30° off vertical.

18. An apparatus as claimed in claim 10 wherein the at least one semi-permeable membrane is a reverse osmosis membrane.

19. An apparatus as claimed in claim 18, wherein the at least one reverse osmosis membrane comprises an array of pressure vessels containing multiple reverse osmosis membranes.
